(19) United States
(12) Patent Application Publication
(10) Pub. No.: US 2009/0286579 A1
(43) Pub. Date: Nov. 19, 2009

(54) Intelligent Wireless Device Indicator

(75) Inventors: Teresa Warnick, Overland Park, KS (US); David Hanneman, Olathe, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/120,340

(22) Filed: May 14, 2008

(51) Int. Cl. H04M 1/00

(52) U.S. Cl. 455/575.1

(57) ABSTRACT

To generate information on possible causes of failure for a wireless device, indicator(s) to a wireless device and a method of manufacture may be used. One method of manufacturing a wireless device includes providing a housing. Electronics may be positioned within the housing. At least one article may also be positioned within the housing. The article(s) may be configured to indicate that a chemical agent has entered the housing or being configured to indicate that the electronics have been exposed to a temperature outside of a temperature range for operation of the electronics.

### BACKGROUND OF THE INVENTION

A wireless device enables a consumer to access a communications network. There are many different communications networks, including mobile communications networks and the Internet. The wireless device may be a mobile telephone, personal digital assistant (PDA), or any type of device capable of communicating over the network. A typical wireless device can be free or cost a few hundred dollars or more. The actual cost of a wireless device to a consumer is often highly subsidized by a service provider in exchange for a fixed-length service contract. By providing the wireless device at a discount, consumers are often willing to agree to the service contract and agree to pay monetary penalties if the contract is ended prematurely.

In the event that the consumer's wireless device breaks, the price of a replacement wireless device often is not subsidized and can be much more expensive than the consumer originally paid. To minimize the risk of an expensive replacement, service providers, equipment manufacturers, or another third party often provide an optional warranty for damaged or broken wireless devices. There may be exclusions in the warranty in the event that damage was caused through the fault of the consumer. For the consumer-fault-exclusion type warranty, damage would only be covered if the wireless device was damaged because of a defect in the phone, and not by consumer misuse.

A problem exists today with making a determination as to an exact cause of the damage and whether the warranty should cover the cost of the repair. Consumers bring or mail in their broken wireless device and the service provider typically makes the determination if the warranty will be honored with little or no reliable evidence of how the broken wireless device was damaged. Having more detailed information available would allow a warrantor to justify the denial of warranty benefits and can lead to substantial savings in costs to the warrantor.

### BRIEF SUMMARY OF THE INVENTION

To generate additional information on possible causes of failure for a wireless device, modifications to a wireless device and a method of manufacture may be used. Because users of wireless devices often expose their wireless devices to liquids and temperature extremes, modifications may include one or more indicators to identify not only that the wireless device was exposed to liquid, but may identify a certain type of liquid having chemical agents (e.g., chlorine, detergent, bleach, etc.)

One embodiment includes a wireless device comprising a housing. Electronics are positioned within the housing. At least one article may be positioned within the housing and configured to indicate that a chemical agent has entered the housing.

Another embodiment includes a wireless device comprising a housing. Electronics are positioned within the housing. At least one article may positioned within the housing and configured to indicate that the electronics have been exposed to a temperature outside of a temperature range for operation of the electronics.

Another embodiment includes a method of manufacturing a wireless device comprising providing a housing. Electronics may be positioned within the housing. At least one article may be positioned within the housing, where the article may be configured to indicate that a chemical agent has entered the housing, or that the electronics have been exposed to a temperature outside of a temperature range for operation of the electronics.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary wireless device;

FIG. 2 is an exploded view of an exemplary wireless device configured to provide historical environmental information of the wireless device; and

FIG. 3 is a flow chart of an exemplary process for manufacturing a wireless device configured to provide historical environmental information of the wireless device.

### DETAILED DESCRIPTION OF THE INVENTION

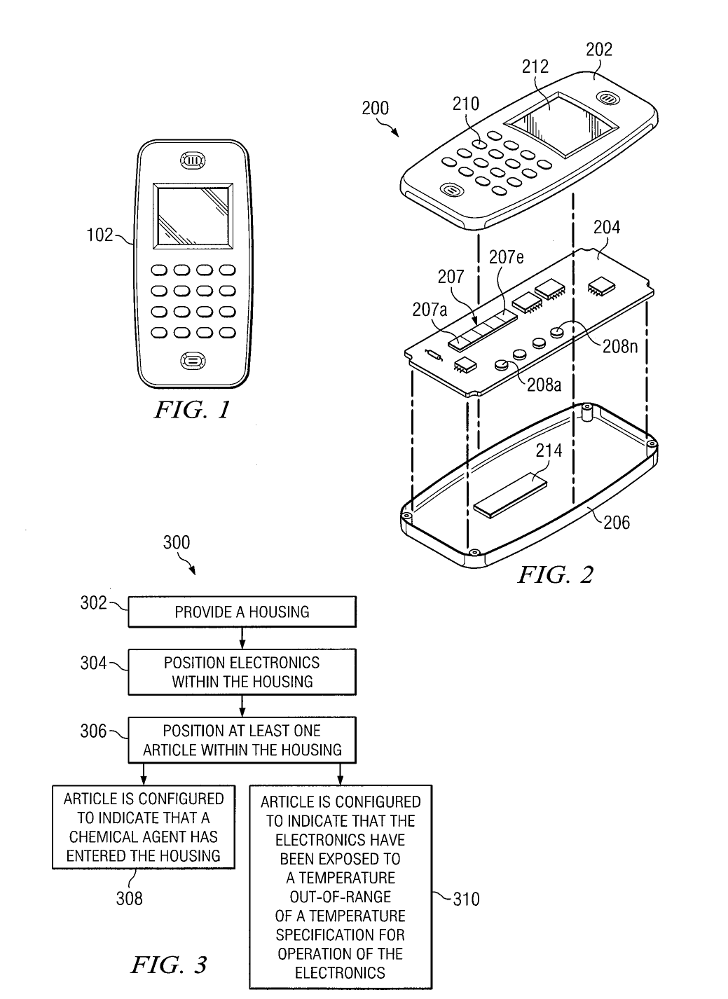

FIG. 1 is an illustration of an exemplary wireless device 102. The wireless device 102 may be a cellular phone, a personal digital assistant (PDA), laptop computer, or any electronic device capable of communicating over a network (not shown). The network may be a cellular network, LAN, the Internet, or any network operable to communicate data or voice. In an alternative embodiment, the device need not be operable to communicate over a network, but may contain electronics used for other purposes. While the description is directed towards a wireless device, any type of electronic equipment may benefit from use of the principles of the present invention.

FIG. 2 is an exploded view of an exemplary wireless device 200 configured to provide historical environmental information of the wireless device 200. A faceplate 202 configured as a front housing component may be positioned on one side of an electronics board 204, with a back housing 206 on the opposite side of the electronic board 204. The faceplate 202 and back housing 206 may serve as a protective covering for the electronics board 204 positioned therein. The faceplate 202 may be made of plastic, rubber, metal, or any other material. The faceplate 202 may also contain a keypad 210 for entering data into the wireless device 200 (i.e., into the electronics board 204) and a screen 212 for providing visual output to a user. The back housing 206 may be made out of any material suitable for protecting and containing the electronic equipment 204 within the wireless device 200. Frequently, the material may be the same as the faceplate 200, but the material need not be the same.

The electronics board 204 may contain electronics that enable the wireless device 200 to perform various functions. Some example electronics include digital signaling processing (DSP) chips, Digital-to-Analog and Analog-to-Digital converters, memory, microprocessors, RF and power supplies, transmit and receive amplifiers, among may others. The electronics may be sensitive to various environmental conditions, such as temperature, moisture, humidity, and shock, among others. By including a test strip 207 or test “buttons” 208a-208n (collectively 208), any environmental conditions that the wireless device 202 is exposed to may be more readily identifiable. The test strip 207 or buttons 208 may be formed of one or more materials. For example, a plastic base or holder may be used to mount a paper or other material that may include a chemical reagent used to detect or otherwise react (e.g., change color) when exposed to one or more chemical agents.

The test strip 207 may be capable of detecting any of the previously described environmental conditions. The test strip 207 may be mounted directly onto the electronics board 204, mounted on either the faceplate 202 or back housing 206, or anywhere within the wireless device 200. For example, test strip 214 is depicted as being mounted on the back housing 206. In mounting or positioning a test strip or button, the test strip or button may include an adhesive backing or a separate adhesive may be utilized. Alternatively, hardware, such as screws, clips, fasteners, or otherwise may be utilized to position or dispose a test strip or button within the housing. Other fastener, including solder, may be utilized in accordance with the principles of the present invention.

The test strip 207 may be segmented into sub-sections 207a-207e that sense various chemical agents. For example, one section may detect chlorine, another may detect salt, another may detect detergent, while another may detect the presence of any other type of chemical agent (e.g., bleach). In another embodiment, there may be multiple test strips 207 positioned within housing components defined by faceplate 202 and back housing 206, each test strip being able to test for the presence of a single or multiple number of chemical agents. The test strip 207 may change color, dissolve, complete a circuit, or may respond in any number of ways that would be indicative of the electronics board 204 coming into contact with the chemical agent. In one embodiment the test strip 207 or test button 208 may change color depending upon the saturation level of the chemical agent to which it is exposed. One or more test strips may detect the presence of water in addition to or instead of chemical agents.

The test buttons 208 may work the same or similarly to the test strip 207. Similar to the test strip 207, the test buttons 208 may also be located anywhere within the wireless device 200. Regardless of the shape, the functionality of the test strip 207 and test buttons 208 may provide the same information.

An example of a test strip 207 or test button 208 that tests for the presence of moisture is Cobalt Chloride test paper. For example, Cobalt Chloride may turn from blue to pink if the test strip 207 or test button 208 is exposed to water or high humidity. Another example of a test strip 207 or test button 208 is litmus paper, which varies in color based on the pH level of the exposed chemical(s). A universal indicator, as is commonly known in the art is typically composed of water, methanol, propan-1-ol, phenolphthalein sodium salt, methyl red sodium salt, bromothymol blue monosodium salt, and thymol blue monosodium salt. The acidity or alkalinity of the exposed chemical agents may be represented by the reactions of these various elements. These examples of reagents are not intended to limit the invention to the reagents listed, but to provide examples that are all within the scope of principles of the present invention.

In addition to moisture, another common problem for electronics is being exposed to temperature levels out of a safe operating range. For example, the wireless device 200 may be changed by a user leaving the wireless device 200 in a vehicle during a hot summer day or over night during the winter. A test button 208 may be composed of a material that responds differently at various temperatures, similar to a thermometer, but may be any material having temperature sensitive properties. One or more test buttons may also have the ability to indicate an approximate minimum and maximum temperature that the wireless device was exposed. By having an indication that the wireless device 200 was exposed to an extreme temperature, in either direction, a warrantor may be able to have proof that the wireless device 200 malfunctioned because of user abuse rather than a defect with the product. An example of an indication that a temperature has been crossed might be a color change of the test button 208, a change in shape of the test button 208, destruction of the test button, or any other type of indication that is capable of being stored or remains visible upon return to normal conditions, in order to provide historical temperature information to the warrantor. (Materials or configurations that can provide historical temp. info?) In one embodiment, rather than using a test button or test strip, a thermometer that is capable of displaying a maximum and/or minimum temperature may be positioned within the wireless device 200.

In filing for a warranty claim, a consumer may be more likely to be honest knowing that detection equipment is present within their wireless device. In addition, if the detection equipment is not advertised, the warrantor may use the information as proof or for justification for denial of a claim. By having more detailed forensic information on the exact cause of the damage to the wireless device 200, a warrantor may be able to reduce costs by only having to service or replace the devices under warranty that rightly qualify.

FIG. 3 is a flow chart of an exemplary process for manufacturing a wireless device operable to provide historical environmental information of the wireless device. In step 302, a housing is provided for the wireless device. The housing may be plastic, metal, rubber, or any solid material operable to protect the wireless device. In step 304, electronics may be positioned within the housing of the wireless device. The electronics may include electronics and software for operating the wireless device and generally may be sensitive to environmental conditions, such as temperature, moisture, and/or chemical agents. In step 306, at least one article may be positioned within the housing. The article may vary depending on the function in which it is to perform. For example, in step 308, the article is configured to indicate that a chemical agent has entered the housing. The article in step 308 may be a litmus-type paper that changes color upon exposure to a certain chemical. The article, optionally configured as a test strip, may be segmented into sub-sections to react to multiple chemicals by the article, or may just react to one chemical. There may be any number of test strips used to detect testing for various environmental conditions. The article in step 310 may be a thermometer or other sensor that reacts to various temperatures. Any number of articles may be used to detect the various conditions.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A wireless device, comprising:
a housing;
electronics positioned within said housing and configured to provide wireless communications via a communications network; and
at least one article positioned within said housing and configured to indicate that a chemical agent has entered said housing.

2. The wireless device according to claim 1, wherein said at least one article is a test strip.

3. The wireless device according to claim 2, wherein the test strip is configured to identify the chemical agent from among a plurality of chemical agents.

4. The wireless device according to claim 1, wherein said at least one article is configured to indicate a saturation level of the chemical agent.

5. The wireless device according to claim 1, wherein the chemical agent is chlorine.

6. The wireless device according to claim 1, wherein the wireless communications include voice communications.

7. The wireless device according to claim 1, further comprising at least one second article positioned within said housing configured to indicate that water has entered said housing.

8. A wireless device, comprising:
a housing;
electronics positioned within said housing and configured to provide wireless communications via a communications network; and
at least one article positioned within said housing and configured to indicate that said electronics have been exposed to a temperature outside of a temperature range for operation of said electronics.

9. The wireless device according to claim 8, wherein said at least one article is a thermometer.

10. The wireless device according to claim 8, wherein said at least one article is configured to indicate that a high or low temperature point has been crossed.

11. The wireless device according to claim 8, wherein said at least one article is configured to indicate a maximum or minimum temperature level to which said at least one article was exposed.

12. A method of manufacturing a wireless device comprising:
providing a housing;
positioning electronics within the housing; and
positioning at least one article within the housing, the at least one article being configured to:
indicate at least one of (i) a chemical agent has entered the housing and (ii) indicate that the electronics have been exposed to a temperature outside of a temperature range for operation of the electronics.

13. The method of manufacturing according to claim 12, wherein positioning the at least one article includes adhering the at least one article to the housing.

14. The method of manufacturing according to claim 12, wherein positioning the at least one article includes positioning a test strip being configured to distinguish the chemical agent from among a plurality of chemical agents.

15. The method of manufacturing according to claim 12, wherein positioning the at least one article includes positioning an article to indicate a saturation level.

16. The method of manufacturing according to claim 12, wherein the chemical agent is chlorine.

17. The method of manufacturing according to claim 12, wherein positioning the at least one article includes positioning a thermometer.

18. The method of manufacturing according to claim 12, wherein said at least one article is configured to indicate that a high or low temperature point has been crossed.

19. The method of manufacturing according to claim 12, wherein said at least one article is configured to indicate a maximum or minimum temperature level to which the at least one article was exposed.
